(19) United States
(12) Patent Application Publication
(10) Pub. No.: US 2015/0237300 A1
(43) Pub. Date: Aug. 20, 2015

(54) On Demand Experience Sharing for Wearable Computing Devices

(71) Applicants: Indika Charles Mendis, Mountain View, CA (US); Maj Isabelle Olsson, Mountain View, CA (US); Max Benjamin Braun, Mountain View, CA (US)

(72) Inventors: Indika Charles Mendis, Mountain View, CA (US); Maj Isabelle Olsson, Mountain View, CA (US); Max Benjamin Braun, Mountain View, CA (US)

(21) Appl. No.: 13/625,985

(22) Filed: Sep. 25, 2012

(51) Int. Cl. H04W 4/02; G06Q 50/14; G02B 27/01; H04W 4/24; H04L 29/06

(52) U.S. Cl. CPC H04N 7/147; H04N 7/142; H04L 65/1059; H04L 65/1083; G02B 27/017; G06Q 50/14; G02B 2027/0178

(57) ABSTRACT

Examples of on-demand experience sharing for wearable computing devices are described. In some examples, on-demand travel assistance can be provided via a live video-chat. An on-demand travel assistance service may connect a wearable device with a travel guide familiar with local languages, restaurants, locations of places, etc. The wearable device may be configured to provide audio and video from a perspective of the wearable device to enable a travel guide to provide expert advice without being present, for example on-demand travel assistance may be available on the wearable device, which may take the form of glasses to allow hands-free use. On-demand travel assistance may be acquired by different types of payment, such as by a usage fee, or a one-time service charge, for example.

### BACKGROUND

Due to modern advances in transportation, people are often able to travel to places and regions that are new and unfamiliar. New geographic locations typically present a number of challenges to first time visitors. For example, first time visitors may encounter new languages and customs. Even people familiar with a particular geographic location may need assistance or additional insight about certain places or customs within the location. People may need assistance with directions, advice, translations, or other additional information. While traveling, people may wish to obtain directions and information about certain places including museums, restaurants, or historical monuments.

Typically, people may resort to acquiring assistance from a person with knowledge about the certain geographic location to overcome the challenges that the foreign place may present. For example, people who specialize in giving advice may be referred to as travel companions. Travel companions may provide information including information or directions to popular restaurants, tourist sites, and exciting experiences for people to try. In addition, a travel companion may be able to assist translating languages that are new or unfamiliar. Different travel companions may have varying levels of knowledge about museums, restaurants, parks, customs, and other unique elements of a geographic location. A person or group of people may hire a travel companion to answer questions and provide services for a predefined cost.

In addition, people often rely on the use of computing devices to assist them within various geographic locations. Whether unfamiliar with the geographic location or simply trying to receive more information about a certain place, people rely on technology to provide them with answers to any obstacles a geographic location may present. Computing devices such as personal computers, laptop computers, tablet computers, cellular phones, and countless types of Internet-capable devices are increasingly prevalent in numerous aspects of modern life, including during travel in new geographic locations. Over time, the manner in which these devices are providing information to users is becoming more intelligent, more efficient, more intuitive, and/or less obtrusive. Examples include travelers using computing devices to access information about a new geographic location from the Internet or using a global positioning system (GPS) to find directions to a place.

Unless otherwise indicated herein, the materials described in this section are not prior art to the claims in this application and are not admitted to be prior art by inclusion in this section.

### SUMMARY

This disclosure may disclose, inter alia, methods and systems for on-demand travel guide assistance.

In one example, a method is provided that includes receiving at a server associated with a travel companion service, a request from a wearable computing device for interaction with a live travel companion that is knowledgeable of aspects of a geographic location of the wearable computing device. The method includes determining the geographic location of the wearable computing device and determining from among a plurality of live travel companions associated with the travel companion service, the live travel companion that is assigned to the geographic location of the wearable computing device, wherein each of the plurality of live travel companions is assigned to a give geographic location. The method also comprises receiving from the wearable computing device real-time video and real-time audio both of which are based on a perspective from the wearable computing device and initiating an experience-sharing session between the wearable computing device and a second computing device associated with the live travel companion, wherein the experience-sharing session includes the real-time video and real-time audio from the wearable computing device. In response to the real-time video and real-time audio, the method includes providing a communication channel between the second computing device and the wearable computing device via the experience-sharing session for real-time interaction.

In another example, an example system is described. The system comprises a processor and memory configured to store program instructions executable by the processor to perform functions. In the example system, the functions include receiving from a wearable computing device a request for interaction with a live travel companion that is knowledgeable of aspects of a geographic location of the wearable computing device and determining the geographic location of the wearable computing device. Additional functions include determining from among a plurality of live travel companions associated with a travel companion service, the live travel companion that is assigned to the geographic location of the wearable computing device, wherein each of the plurality of live travel companions is assigned to a given geographic location, and receiving from the wearable computing device real-time video and real-time audio both of which are based on a perspective the wearable computing device. Further, the functions include initiating an experience-sharing session between the wearable computing device and a second computing device associated with the live travel companion, wherein the experience-sharing session includes the real-time video and real-time audio from the wearable computing device, and in response to the real-time video and real-time audio, providing a communication channel between the second computing device and the wearable computing device via the experience-sharing session for real-time interaction.

Any of the methods described herein may be provided in a form of instructions stored on a non-transitory, computer readable medium, that when executed by a computing device, cause the computing device to perform functions of the method. Further examples may also include articles of manufacture including tangible computer-readable media that have computer-readable instructions encoded thereon, and the instructions may comprise instructions to perform functions of the methods described herein.

In another example, a computer-readable memory having stored thereon instructions executable by a computing device to cause the computing device to perform functions is provided. The functions may comprise receiving at a server associated with a travel companion service, a request from a wearable computing device for interaction with a live travel companion that is knowledgeable of aspects of a geographic location of the wearable computing device. The functions may further include determining the geographic location of the wearable computing device and determining from among a plurality of live travel companions associated with the travel companion service, the live travel companion that is assigned to the geographic location of the wearable computing device. Each of the plurality of live travel companions is assigned to a given geographic location. The functions may also include receiving from the wearable computing device real-time video and real-time audio both of which are based on a perspective from the wearable computing device and initiating an experience-sharing session between the wearable computing device and a second computing device associated with the live travel companion. The experience-sharing session may comprise the real-time video and real-time audio from the wearable computing device. The function may further comprise providing a communication channel between the second computing device and the wearable computing device via the experience-sharing session for real-time interaction in response to the real-time video and real-time audio.

The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage medium.

In addition, circuitry may be provided that is wired to perform logical functions in any processes or methods described herein.

In still further examples, any type of devices or systems may be used or configured to perform logical functions in any processes or methods described herein. As one example, a system may be provided that includes an interface, a control unit, and an update unit. The interface may be configured to provide communication between a client device and a data library. The data library stores data elements including information configured for use by a given client device and that are associated with instructions executable by the given client device to perform a heuristic for interaction with an environment, and the data elements stored in the data library are further associated with respective metadata that is indicative of a requirement of the given client device for using a given data element to perform at least a portion of an associated heuristic for interaction with the environment. The control unit may be configured to determine a data element from among the data elements stored in the data library that is executable by the client device to perform at least a portion of a task of the client device, and to cause the data element to be conveyed to the client device via the interface. The update unit may be configured to provide to the client device via the interface an update of application-specific instructions for use in a corresponding data element stored on the client device.

In yet further examples, any type of devices may be used or configured as means for performing functions of any of the methods described herein (or any portions of the methods described herein).

The foregoing summary is illustrative only and is not intended to be in any way limiting. In addition to the illustrative aspects, examples, and features described above, further aspects, examples, and features will become apparent by reference to the figures and the following detailed description.

### BRIEF DESCRIPTION OF THE FIGURES

FIG. 1 illustrates an example of a wearable computing device and system.

FIG. 2A illustrates an example of a wearable computing device.

FIG. 2B illustrates an alternate view of the device illustrated in FIG. 2A.

FIG. 2C illustrates an example system for receiving, transmitting, and displaying data.

FIG. 2D illustrates another example system for receiving, transmitting, and displaying data.

FIG. 3 is a flow chart illustrating an example method for an experience-sharing session over a communication network.

FIG. 4A illustrates an example scenario involving interaction between a traveler and a travel companion through the use of an experience-sharing session.

FIG. 4B illustrates another example scenario involving interaction between a traveler and a travel companion through the use of an experience-sharing session.

FIG. 5 is a flow chart illustrating an example method for initiating an experience-sharing session with a travel companion.

### DETAILED DESCRIPTION

In the following detailed description, reference is made to the accompanying figures, which form a part thereof. In the figures, similar symbols typically identify similar components, unless context dictates otherwise. The illustrative examples described in the detailed description, figures, and claims are not meant to be limiting. Other examples may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### 1. Overview

This disclosure may disclose, inter alia, methods and systems for on demand experience sharing with a live travel companion that is associated with a head-mountable device (HMD, such as a glasses-style wearable computer. An HMD may connect to a network and request interaction with another computing device associated with a live travel companion. The interaction between a device requesting information and a device associated with a travel companion may include video and audio transmitted in real-time. A network system may provide a communication channel for the sharing the real-time video and audio between computing devices. The network may include components, including servers and nodes, to allow the real-time interaction between a traveler and travel companion. Different types of media may be used for the interaction, including using an experience-sharing session.

A travel companion may be selected from a plurality of travel companions to interact upon request from a device depending on the location of the request. Travel companions may provide assistance to one or more travelers in real-time via an experience-sharing session. Various examples may exist that illustrate possible interactions that may occur between a traveler and travel companion via devices associated with each, respectively.

### 2. Device and System Architecture

a. Example Server System Architecture

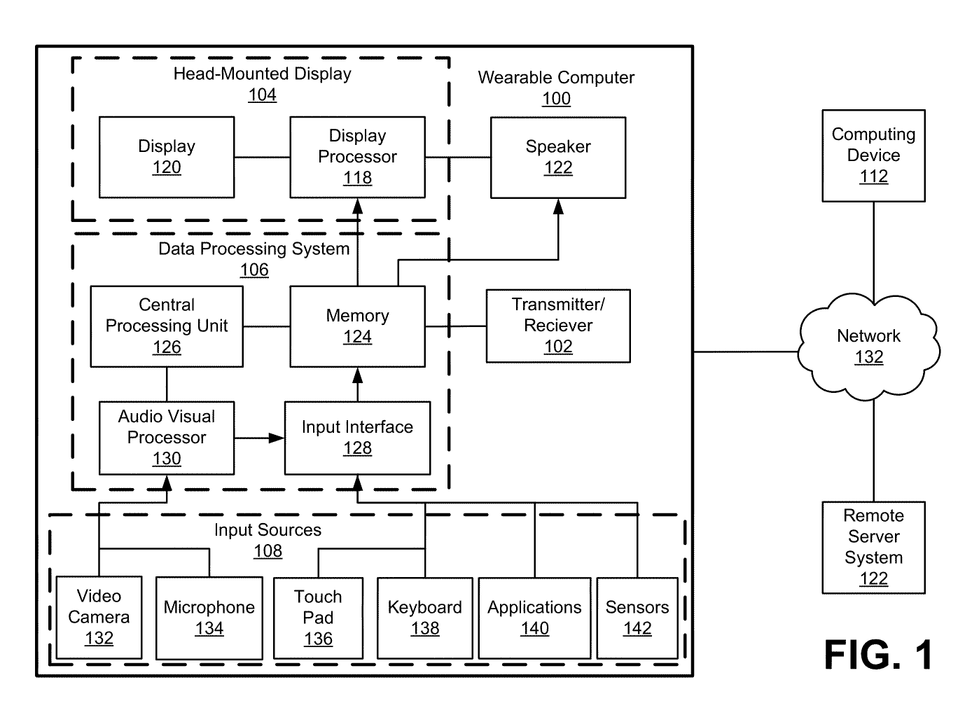

FIG. 1 illustrates an example system for enabling interaction between travelers and travel companions. In FIG. 1, the system is described in a form of a wearable computer 100 that is configured to interact in an experience-sharing session. An experience-sharing session allows transfer of video and audio captured in real-time by one or more wearable computing devices. It should be understood, however, that other types of computing devices may be configured to provide similar sharing-device functions and/or may include similar components as those described in reference to wearable computer 100. The system may enable connection to live travel companions for any travelers who may request interaction for any type of information in various geographic locations.

As shown, the wearable computer 100 includes a transmitter/receiver 102, a head-mounted display (HMD) 104, a data processing system 106, and several input sources 108. FIG. 1 also illustrates a communicative link 110 between the wearable computer 100 and a network 112. Further, the network 112 may connect to a server 114 and one or more computing devices represented by computing device 116, for example.

The transmitter/receiver 102 may be configured to communicate with one or more remote devices through the communication network 112, and connection to the network 112 may be configured to support two-way communication and may be wired or wireless.

The HMD 104 may be configured to display visual objects derived from many types of visual multimedia, including video, text, graphics, pictures, application interfaces, and animations. Some examples of an HMD 104 may include a processor 118 to store and transmit a visual object to a display 120, which presents the visual object. The processor 118 may also edit the visual object for a variety of purposes. One purpose for editing a visual object may be to synchronize displaying of the visual object with presentation of an audio object to the one or more speakers 122. Another purpose for editing a visual object may be to compress the visual object to reduce load on the display 120. Still another purpose for editing a visual object may be to correlate displaying of the visual object with other visual objects currently displayed by the HMD 104.

While FIG. 1 illustrates an example wearable computer configured to interact in real-time with other devices, it should be understood that the wearable computer 100 may take other forms. For example, a computing device may include a mobile phone, a tablet computer, a personal computer, or any other computing device configured to provide real-time interaction described herein. Further, it should be understood that the components of a computing device that serve as a device in an experience-sharing session may be similar to those of a wearable computing device in an experience-sharing session. Further, a computing device may take the form of any type of device capable of providing a media experience (e.g., audio and/or video), such as computer, mobile phone, tablet device, television, a game console, and/or a home theater system, among others.

The data processing system 106 may include a memory system 124, a central processing unit (CPU) 126, an input interface 128, and an audio visual (A/V) processor 130. The memory 124 may include a non-transitory computer-readable medium having program instructions stored thereon. As such, the program instructions may be executable by the CPU 126 to carry out the functionality described herein. The memory system 124 may be configured to receive data from the input sources 108 and/or the transmitter/receiver 102. The memory system 124 may also be configured to store received data and then distribute the received data to the CPU 126, the HMD 106, the speaker 122, or to a remote device through the transmitter/receiver 102. The CPU 126 may be configured to detect a stream of data in the memory system 124 and control how the memory 124 distributes the stream of data. The input interface 128 may be configured to process a stream of data from the input sources 108 and then transmit the processed stream of data into the memory system 124. This processing of the stream of data converts a raw signal, coming directly from the input sources 108 or A/V processor 130, into a stream of data that other elements in the wearable computer 100, computing device 116, and the server 114 can use. The A/V processor 130 may be configured to perform audio and visual processing on one or more audio feeds from one or more of the input sources 108. The CPU 126 may be configured to control the audio and visual processing performed on the one or more audio feeds and the one or more video feeds. Examples of audio and video processing techniques, which may be performed by the A/V processor 130, will be given later.

The input sources 108 include features of the wearable computing device 100 such as a video camera 132, a microphone 134, a touch pad 136, a keyboard 138, one or more applications 140, and other general sensors 142 (e.g. biometric sensors). The input sources 108 may be internal, as shown in FIG. 1, or the input sources 108 may be in part or entirely external. Additionally, the input sources 108 shown in FIG. 1 should not be considered exhaustive, necessary, or inseparable. Other examples may exclude any of the additional set of input devices 108 and/or include one or more additional input devices that may add to an experience-sharing session.

The computing device 116 may be any type of computing device capable of receiving and displaying video and audio in real time. In addition, the computing device 112 may be able to transmit audio and visual in real time to permit live interaction to occur. The computing device 112 may also record and store images, audio, or video in memory. Multiple wearable computing devices may link and interact via the network 132.

b. Example Device Architecture

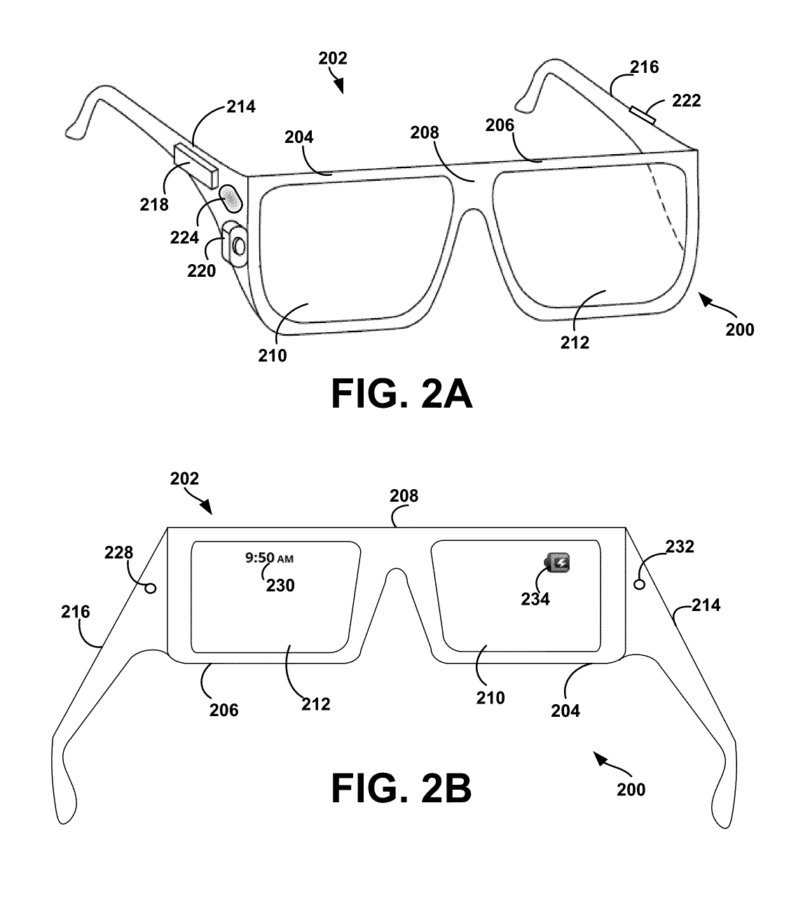

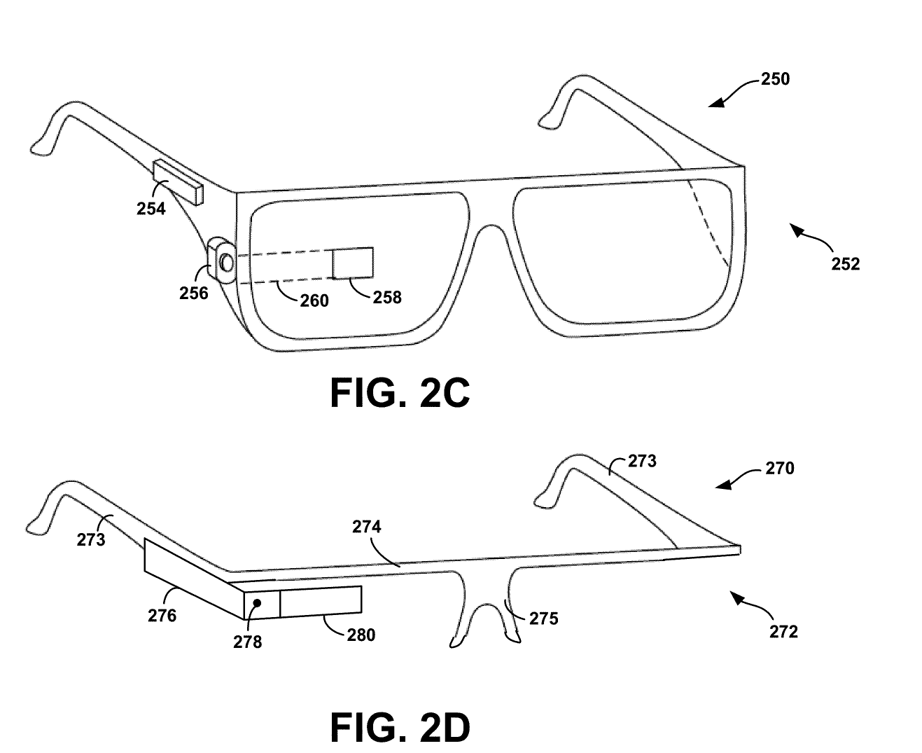

FIG. 2A illustrates an example of a wearable computing device. While FIG. 2A illustrates a head-mounted device 202 as an example of a wearable computing device, other types of wearable computing devices could additionally or alternatively be used. As illustrated in FIG. 2A, the head-mounted device 202 comprises frame elements including lens-frames 204, 206 and a center frame support 208, lens elements 210, 212, and extending side-arms 214, 216. The center frame support 208 and the extending side-arms 214, 216 are configured to secure the head-mounted device 202 to a user's face via a user's nose and ears, respectively.

Each of the frame elements 204, 206, and 208 and the extending side-arms 214, 216 may be formed of a solid structure of plastic and/or metal, or may be formed of a hollow structure of similar material so as to allow wiring and component interconnects to be internally routed through the head-mounted device 202. Other materials may be possible as well.

One or more of each of the lens elements 210, 212 may be configured of any material that may suitably display a projected image or graphic. Each of the lens elements 210, 212 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 214, 216 may each be projections that extend away from the lens-frames 204, 206, respectively, and may be positioned behind a user's ears to secure the head-mounted device 202 to the user. The extending side-arms 214, 216 may further secure the head-mounted device 202 to the user by extending around a rear portion of the user's head. Additionally or alternatively, for example, the system 200 may connect to or be affixed within a head-mounted helmet structure. Other possibilities exist as well.

The system 200 may also include an on-board computing system 218, a video camera 220, a sensor 222, and a finger-operable touch pad 224. The on-board computing system 218 is shown to be positioned on the extending side-arm 214 of the head-mounted device 202; however, the on-board computing system 218 may be provided on other parts of the head-mounted device 202 or may be positioned remote from the head-mounted device 202 (e.g., the on-board computing system 218 could be wire- or wirelessly-connected to the head-mounted device 202). The on-board computing system 218 may include a processor and memory, for example. The on-board computing system 218 may be configured to receive and analyze data from the video camera 220 and the finger-operable touch pad 224 (and possibly from other sensory devices, user interfaces, or both) and generate images for output by the lens elements 210 and 212.

The video camera 220 is shown positioned on the extending side-arm 214 of the head-mounted device 202; however, the video camera 220 may be provided on other parts of the head-mounted device 202. The video camera 220 may be configured to capture images at various resolutions or at different frame rates. Many video cameras with a small form-factor, such as those used in cell phones or webcams, for example, may be incorporated into an example of the system 200.

Further, although FIG. 2A illustrates one video camera 220, more video cameras may be used, and each may be configured to capture the same view, or to capture different views. For example, the video camera 220 may be forward facing to capture at least a portion of the real-world view perceived by the user. This forward facing image captured by the video camera 220 may then be used to generate an augmented reality where computer generated images appear to interact with the real-world view perceived by the user.

The sensor 222 is shown on the extending side-arm 216 of the head-mounted device 202; however, the sensor 222 may be positioned on other parts of the head-mounted device 202. The sensor 222 may include one or more of a gyroscope or an accelerometer, for example. Other sensing devices may be included within, or in addition to, the sensor 222 or other sensing functions may be performed by the sensor 222.

The finger-operable touch pad 224 is shown on the extending side-arm 214 of the head-mounted device 202. However, the finger-operable touch pad 224 may be positioned on other parts of the head-mounted device 202. Also, more than one finger-operable touch pad may be present on the head-mounted device 202. The finger-operable touch pad 224 may be used by a user to input commands. The finger-operable touch pad 224 may sense at least one of a position and a movement of a finger via capacitive sensing, resistance sensing, or a surface acoustic wave process, among other possibilities. The finger-operable touch pad 224 may be capable of sensing finger movement in a direction parallel or planar to the pad surface, in a direction normal to the pad surface, or both, and may also be capable of sensing a level of pressure applied to the pad surface. The finger-operable touch pad 224 may be formed of one or more translucent or transparent insulating layers and one or more translucent or transparent conducting layers. Edges of the finger-operable touch pad 224 may be formed to have a raised, indented, or roughened surface, so as to provide tactile feedback to a user when the user's finger reaches the edge, or other area, of the finger-operable touch pad 224. If more than one finger-operable touch pad is present, each finger-operable touch pad may be operated independently, and may provide a different function.

FIG. 2B illustrates an alternate view of the system 200 illustrated in FIG. 2A. As shown in FIG. 2B, the lens elements 210, 212 may act as display elements. The head-mounted device 202 may include a first projector 228 coupled to an inside surface of the extending side-arm 216 and configured to project a display 230 onto an inside surface of the lens element 212. Additionally or alternatively, a second projector 232 may be coupled to an inside surface of the extending side-arm 214 and configured to project a display 234 onto an inside surface of the lens element 210.

The lens elements 210, 212 may act as a combiner in a light projection system and may include a coating that reflects the light projected onto them from the projectors 228, 232. In some examples, a reflective coating may not be used (e.g., when the projectors 228, 232 are scanning laser devices).

In alternative examples, other types of display elements may also be used. For example, the lens elements 210, 212 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 204, 206 for driving such a matrix display. Alternatively or additionally, a laser or LED source and scanning system could be used to draw a raster display directly onto the retina of one or more of the user's eyes. Other possibilities exist as well.

FIG. 2C illustrates an example system for receiving, transmitting, and displaying data. The system 250 is shown in the form of a wearable computing device 252. The wearable computing device 252 may include frame elements and side-arms such as those described with respect to FIGS. 2A and 2B. The wearable computing device 252 may additionally include an on-board computing system 254 and a video camera 256, such as those described with respect to FIGS. 2A and 2B. The video camera 256 is shown mounted on a frame of the wearable computing device 252; however, the video camera 256 may be mounted at other positions as well.

As shown in FIG. 2C, the wearable computing device 252 may include a single display 258 which may be coupled to the device. The display 258 may be formed on one of the lens elements of the wearable computing device 252, such as a lens element described with respect to FIGS. 2A and 2B, and may be configured to overlay computer-generated graphics in the user's view of the physical world. The display 258 is shown to be provided in a center of a lens of the wearable computing device 252; however, the display 258 may be provided in other positions. The display 258 is controllable via the computing system 254 that is coupled to the display 258 via an optical waveguide 260.

FIG. 2D illustrates an example system for receiving, transmitting, and displaying data. The system 270 is shown in the form of a wearable computing device 272. The wearable computing device 272 may include side-arms 273, a center frame support 274, and a bridge portion with nosepiece 275. In the example shown in FIG. 2D, the center frame support 274 connects the side-arms 273. The wearable computing device 272 does not include lens-frames containing lens elements. The wearable computing device 272 may additionally include an on-board computing system 276 and a video camera 278, such as those described with respect to FIGS. 2A and 2B.

The wearable computing device 272 may include a single lens element 280 that may be coupled to one of the side-arms 273 or the center frame support 274. The lens element 280 may include a display such as the display described with reference to FIGS. 2A and 2B, and may be configured to overlay computer-generated graphics upon the user's view of the physical world. In one example, the single lens element 280 may be coupled to the inner side (i.e., the side exposed to a portion of a user's head when worn by the user) of the extending side-arm 273. The single lens element 280 may be positioned in front of or proximate to a user's eye when the wearable computing device 272 is worn by a user. For example, the single lens element 280 may be positioned below the center frame support 274, as shown in FIG. 2D.

As described in the previous section and shown in FIG. 1, some exemplary examples may include a set of audio devices, including one or more speakers and/or one or more microphones. The set of audio devices may be integrated in a wearable computer 202, 250, 270 or may be externally connected to a wearable computer 202, 250, 270 through a physical wired connection or through a wireless radio connection.

### 3. Example of Cloud-Based Interaction in Real Time

A server can help reduce a processing load of a wearable computing device. For example, a wearable computing device may interact within a remote, cloud-based server system, which can function to distribute real-time audio and video to appropriate computing devices for viewing. As part of a cloud-based implementation, the wearable computing device may communicate with the server system through a wireless connection, through a wired connection, or through a network that includes a combination of wireless and wired connections. The server system may likewise communicate with other computing devices through a wireless connection, through a wired connection, or through a network that includes a combination of wireless and wired connections. The server system may then receive, process, store, and transmit any video, audio, images, text, or other information from the wearable computing device and other computing devices. Multiple wearable computing devices may interact within the remote server system.

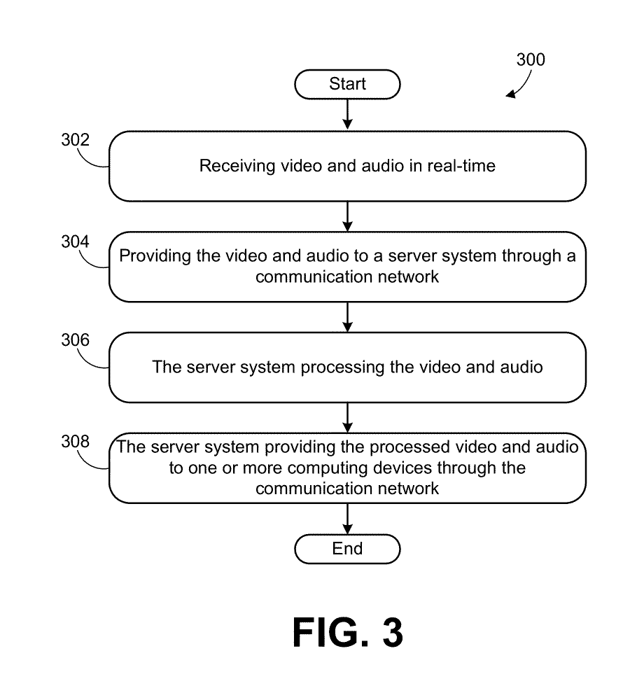

FIG. 3 is a flow chart illustrating an example method 300 for an experience-sharing session over a communication network. The method 300 shown in FIG. 3 presents an embodiment of a method that could, for example, be used by the wearable computer 100 of FIG. 1. Method 300 may include one or more operations, functions, or actions as illustrated by one or more of blocks 302-308. Although the blocks are illustrated in a sequential order, these blocks may also be performed in parallel, and/or in a different order than those described herein. Also, the various blocks may be combined into fewer blocks, divided into additional blocks, and/or removed from the method, based upon the desired implementation of the method.

In addition, for the method 300 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and random access memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

In addition, for the method 300 and other processes and methods disclosed herein, each block in FIG. 3 may represent circuitry that is wired to perform the specific logical functions in the process.

At block 302, the method 300 includes receiving video and audio in real-time. In some examples, a wearable computing device may receive video and audio using cameras, microphones, or other components. The capturing of video and audio in-real time may be performed by any of the components as described in FIGS. 1-2.

At block 304, the method 300 includes providing video and audio to a server system through a communication network. In some examples, the wearable computing device may transmit captured video and audio to a server system through a communication network.

At block 306, the method 300 includes the server system processing the video and audio, and at block 308, the method 300 includes the server system providing the processed video and audio to one or more computing devices through the communication network.

A server system may process captured video and audio in various ways. In some examples, a server system may format media components of the captured video and audio to adjust for a particular computing device. For example, consider a computing device that is participating in an experience-sharing session via a website that uses a specific video format. In this example, when the wearable computing device sends captured video, the server system may format the video according to the specific video format used by the website before transmitting the video to the computing device. As another example, if a computing device is a personal digital assistant (PDA) that is configured to play audio feeds in a specific audio format, then the server system may format an audio portion of the captured video and audio according to the specific audio format before transmitting the audio portion to other computing devices. These examples are merely illustrative, and a server system may format the captured video and audio to accommodate give computing devices in various other ways. In some implementations, a server system may format the same captured video and audio in a different manner for different computing devices in the same experience-sharing session.

In still other examples, a server system may be configured to compress all or a portion of the captured video and audio before transmitting the captured video and audio to a computing device. For example, if a server system receives high-resolution captured video and audio, the server may compress the captured video and audio before transmitting the captured video and audio to the one or more computing devices. In this example, if a connection between the server system and a certain computing device runs too slowly for real-time transmission of the high-resolution captured video and audio, then the server system may temporally or spatially compress the captured video and audio and transmit the compressed captured video and audio to the computing device. As another example, if a computing device requires a slower frame rate for video feeds, a server system may temporally compress a captured video and audio by removing extra frames before transmitting the captured video and audio to the computing device. As yet another example, a server system may be configured to save bandwidth by down sampling a video before transmitting the video to a computing device that can handle a low-resolution image. In this example, the server system may be configured to perform pre-processing on the video itself, for example, by combining multiple video sources into a single video feed, or by performing near-real-time transcription (or, in other words, closed captions) or translation.

Further, a server system may be configured to decompress captured video and audio, which may enhance a quality of an experience-sharing session. In some examples, a wearable computing device may compress captured video and audio before transmitting the captured video and audio to a server system, in order to reduce transmission load on a connection between the wearable computing device and the server system. If the transmission load is less of a concern for the connection between the server system and a given computing device, then the server system may decompress the captured video and audio prior to transmitting the captured video and audio to the computing device. For example, if a wearable computing devices uses a lossy spatial compression algorithm to compress captured video and audio before transmitting the captured video and audio to a server system, the server system may apply a super-resolution algorithm (an algorithm that estimates sub-pixel motion increasing the perceived spatial resolution of an image) to decompress the captured video and audio before transmitting the captured video and audio to one or more computing devices. In other examples, a wearable computing device may use a lossless data compression algorithm to compress captured video and audio before transmission to a server system, and the server system may apply a corresponding lossless decompression algorithm to the captured video and audio so that the captured video and audio may be usable by a given computing device.

### 4. Examples of Experience Sharing

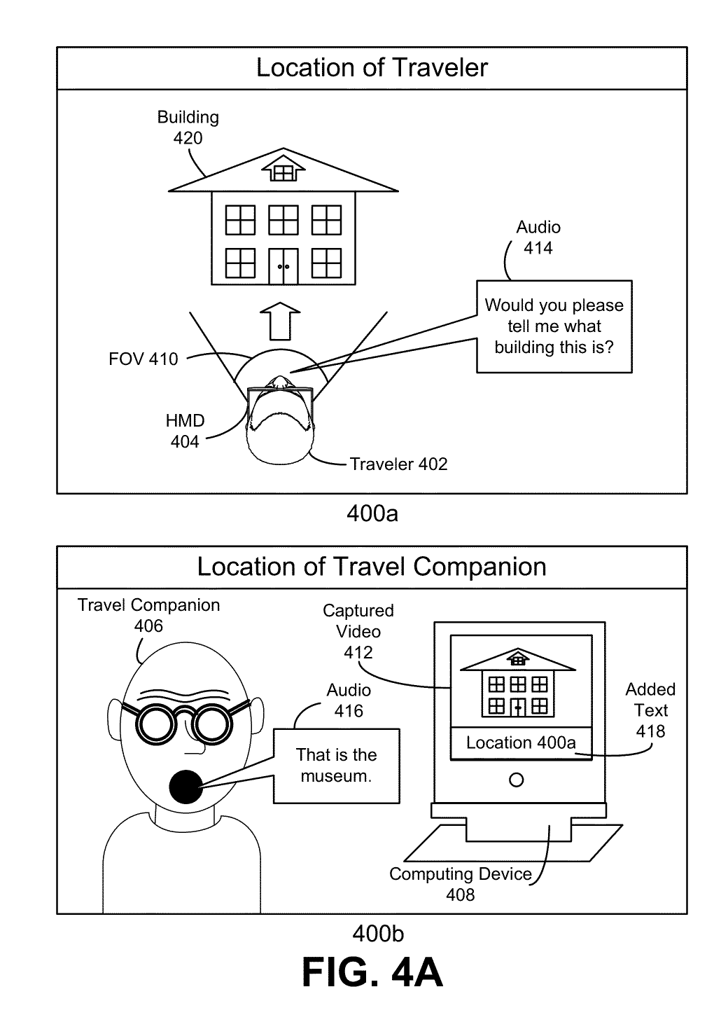

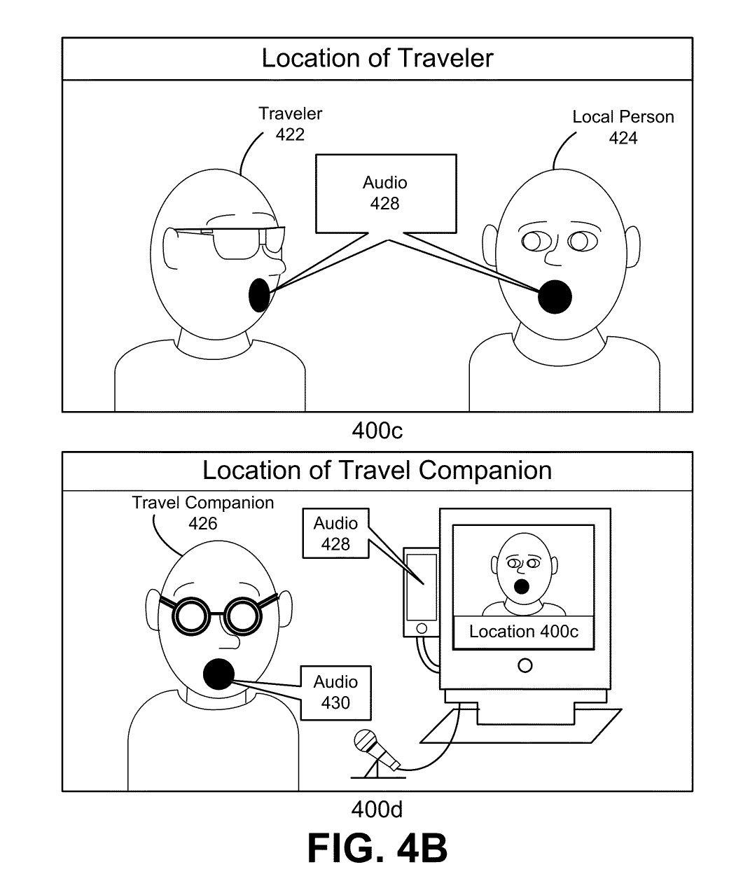

FIGS. 4A and 4B illustrate examples for experience-sharing sessions between a wearable computer of a traveler and a computing device of a live travel companion. FIG. 4A illustrates an example for a traveler 402 in a first location 400a requesting and interacting with a live travel companion 406 in a second location 400b to receive more information about a building via an experience-sharing session. In the example, a traveler 402 uses an HMD 404 to request and interact with a travel companion 406 via a communication channel on a network. The HMD 404 may be configured to connect and enable interaction with a computing device 408 of the travel companion 406 by sending real-time captured video 412 and audio 414. The computing device 408 may be configured to display the captured video 412 from the HMD 404 to enable the travel companion 406 to view the same field of view (FOV) 410 as the traveler 402. The captured video 412 shows a building 420 that is currently being viewed by the traveler 402. While viewing building 420 during the live interaction with the travel companion 406, the traveler 402 may ask a question generating audio 414, which is captured by the HMD 404 and provided in real-time to the computing device 408 along with the real-time captured video 412. The travel companion 406 may use added text 418 displayed by computing device 408 to recognize that the traveler 402 is currently located in location 400a. Once the location of the traveler 402 is known, the travel companion 406 may then use knowledge of that geographic location to respond to the question (audio 414) of the traveler 402 with an answer (audio 416). Specifically within the example illustrated by FIG. 4A, the traveler 402 asks “Would you please tell me what building this is?” while capturing video of the building 420 with the HMD 404. Knowing both the location of the traveler 402 and able to hear and see the same things as the traveler 402, the travel companion 406 may analyze the question and answer with “That is the museum,” despite being located remotely in location 400b. The interaction occurring within the example may differ depending on numerous elements. Other variations and examples may exist that are similar to the example in FIG. 4A.

FIG. 4A illustrates two separate locations, location 400a and location 400b. Location 400a represents the geographic location of the traveler 402 and location 400b represents the geographic location of the travel companion 406. Location 400a and location 400b may each represent any geographic location including the same one. Traveler 402 may have a various range of experience and knowledge about location 400a. Traveler 402 may be traveling in location 400a for the first time or live in location 400a year-round, for example. Location 400b may be a remote location where only travel companion 406 operates, or may contain a plurality of travel companions. Location 400b may differ completely from, overlap, or cover the same area as location 400a. In some examples, location 400b may also exist in a different time zone than location 400a.

In the example illustrated by FIG. 4A, traveler 402 may initiate interaction with travel companion 406 through a specific command. The command may be any gesture, input, or other motion to cause the HMD 404 to respond by initiating an experience-sharing session with travel companion 406. In one example, the HMD 404 may send a request for interaction by voice activation. After initiating interaction, traveler 402 may communicate in real-time with travel companion 406 via an experience-sharing session linked on a service network, for example.

As noted above, traveler 402 may use the HMD 404 to initiate an experience-sharing session with travel companion 406. In the example illustrated by FIG. 4A, the HMD 404 is in the form of glasses allowing a hands-free experience for traveler 402. In other examples, traveler 402 may use one or more different types of computing devices instead of the HMD 404 as discussed by FIGS. 2A-2D. Devices coupled to the HMD 404 may enable the travel companion 406 to receive captured video 412 and audio from the surrounding environment of traveler 402, all within real-time. This simulates the situation of travel companion 406 actually physically accompanying traveler 402. The HMD 404 may relay pictures, videos, recordings, real-time video, audio, and other forms of data across a network connection to travel companion 406 for analysis. In one example, traveler 402 may use the HMD 404 to link to other HMDs of other travelers to interact in real-time.

The example illustrated in FIG. 4A depicts travel companion 406 interacting from location 400b with traveler 402, who is in location 400a. In other examples, travel companion 406 may occupy and operate from any location that allows connection to the network system that provides communication channels for interaction with traveler 402. Thus, a plurality of travel companions may operate from the same location, or each travel companion may provide assistance from various remote locations. A server or method may exist to interconnect all of the travel companions and allow the selection of the best travel companion for a certain request. In some examples, a travel companion may operate within the geographic location that the travel companion is assigned to provide service to any travelers, enabling the possibility of having the live companion accompany the traveler in person and circumvent the reliance upon technology in some situations.

In the example illustrated by FIG. 4A, the computing device 408 receives the request for interaction from the HMD 404, and in response, establishes an experience-sharing session. Computing device 408 may receive the initial request from the HMD 404 for interaction and alert travel companion 406 for confirmation. Computing device 408 may also interact in real-time with the HMD 404 of traveler 402. In other examples, a travel companion may use a computing device that permits only responses through picture images and text messages, but not real-time audio and video. Travel companion 406 may use various other devices instead of computing device 408, including any of the devices in FIGS. 2A-2D. In one embodiment, computing device 408 may have the ability to send requests to the HMDs of travelers to initiate interaction. In this embodiment, both the traveler and travel companion may request interaction with the other. In the example illustrated by FIG. 4A, computing device 408 displays the captured video 412 along with added text 418 on a screen. The audio 414 received from the HMD 404 of traveler 402 may be reproduced by a speaker coupled to the computing device 408.

In the example in FIG. 4A, travel companion 406 receives captured video 412 representing the field of view (FOV) 410 of traveler 402 from one or more cameras coupled to the HMD 404 of the traveler 402. In another example, the HMD 404 of traveler 402 may include more cameras to provide a larger area than the FOV 410 of traveler 402 to the travel companion 406. The captured video 412 and transfer of captured video between two devices may follow all or some of the functions described in FIG. 3.

In the example illustrated by FIG. 4A, traveler 402 asks a question aloud (audio 414) which is captured by the HMD 404 and transmitted in real-time across the network to the computer device 408 of travel companion 406. In other examples, the traveler 402 may record videos and/or audio and send the recordings at a later time with additional questions in the form of visual text or audio to travel companion 406 for analysis and/or response. In the example of FIG. 4A, traveler 402 asks “What building is this?” (audio 414). Traveler 402 asks the question while capturing building 420 within the FOV 410 of traveler 402 through the use of one or more cameras connected to the HMD 404. In other examples, traveler 402 may communicate other ideas, greetings, or any audible sound through the HMD 404. Audio 414 may also represent audio that may be captured by the HMD 404 from the surroundings of traveler 402. For example, traveler 402 may be at a concert listening to music and audio 414 may represent the music being captured by one or more microphones of the HMD 404. Travel companion 406 may hears audio 414 in real-time through speakers connected with the computing device 408 while also simultaneously viewing the building 420 in the captured video 412. In other examples, travel companion 406 may merely hear audio 414 before having a chance to view the captured video 412. This may occur during a poor connection between the HMD 404 and computing device 408.

In response to initially connecting with traveler 402, travel companion 406 may communicate in real-time with advice, questions, comments, answers, or communication elements, for example. In the example illustrated by FIG. 4A, audio 416 represents an answer from travel companion 406 to the question (audio 414) of traveler 404. Travel companion 406 answers the question of traveler 402 by responding “That is the museum” (audio 416). Audio 416 may be sent in real-time to HMD 404, or may be sent as a recording. The HMD 404 of traveler 402 may play audio 416 in a headphone for traveler 402 to hear or may play audio 416 through a speaker, out loud. After receiving audio 416, traveler 402 may choose to end the experience-sharing session or continue with the communication.

In other examples, audio 414, 416 may represent various communications between travel companion 406 and traveler 402, and may include continuous streaming of audio and video data, or discrete portions of audio and video data. Traveler 402 may turn off the microphones associated with HMD 404 to prevent interrupting travel companion 406. For example, a travel companion may be providing a tour of a museum and travelers may choose to limit the noise from their surroundings being captured by the HMDs by keeping their HMDs' microphones on mute except when they may have a question. In addition, travel companion 406 may be able to mute the microphone of computing device 408.

In the example illustrated by FIG. 4A, computing device 408 of travel companion 406 also displays added text 418, which may be the address of the traveler (location 400a). By adding the address on the screen in addition to the captured video 412, travel companion 406 may more accurately understand the current location of traveler 402 and provide better help overall. For example, travel companion 406 may need an address of the current location of traveler 402 to provide directions to another destination for traveler 402. In other examples, the added text 418 may be a different type of information, such as a textual question sent by traveler 402 or biographical information about traveler 402. In one embodiment, computing device 408 may not display added text 418 or may use an audible form of added text 418.

In other examples, travel companion 406 may interact with traveler 402 by sending graphical images or textual images to be displayed on the lens of HMD 404. For example, in the case that traveler 402 asked for directions to building 420, travel companion 406 may transmit directions along with a map and text instructions to HMD 404 for traveler 402 to view and follow.

FIG. 4B illustrates another example for a traveler initiating an experience-sharing session with a travel companion for live interaction to receive assistance. In the example, traveler 422 is communicating with local person 424 and requires assistance translating the language used by local person 424. In some scenarios, the example illustrated in FIG. 4B may combine or coexist with the example illustrated FIG. 4A, or a combination of the elements of the examples. For example, a traveler may require assistance, directions, and a translation during one interaction session with a travel companion.

The example illustrated by FIG. 4B depicts traveler 422 communicating with local person 424 and simultaneously interacting with travel companion 426 to receive assistance communicating with local person 424. Location 400c represents the geographic location of traveler 422 and local person 424, and location 400d represents the geographic location of travel companion 426. Traveler 422 is using an HMD to interact via an experience-sharing session with travel companion 426. A communication channel across the network of the service enables real-time interaction to occur between traveler 422 and travel companion 426. A computing device allows travel companion 426 to see and hear the surroundings of traveler 422 that the HMD captures. In the example, audio 428 represents the communication occurring between traveler 422 and local person 424. The computing device of travel companion 426 shows the captured video and plays the audio that is received from the HMD of the traveler. Travel companion 426 is able to listen to audio 428 and assist traveler 422 by any means. Audio 430 represents the translations and advice travel companion 426 is providing to traveler 422 via a microphone connected to the computer device that is linked to the HMD of traveler 422. Variations of the example may exist.

In the example illustrated by FIG. 4B, location 400c and location 400d may represent other locations, including the same one. Other examples may exist for the locations as discussed in FIG. 4A.

In the example, traveler 422 initiated interaction with travel companion 426 to receive assistance communicating with local person 424. Traveler 422 may have a varying level of ability to communicate with local person 424. For example, traveler 422 may understand local person 424, but may be unable to speak in that language to respond. Other possibilities may exist for traveler 422 initiating an experience sharing session with travel companion 426. For example, traveler 422 and local person 424 may be trying to reach the same destination and use the HMD of the traveler to receive directions from travel companion 426 for both of them.

In the example illustrated by FIG. 4B, local person 424 is a person in communication with traveler 422. In other examples, local person 424 may be replaced by group of people. In addition, local person 424 may be replaced by a piece of written communication that traveler 422 may not be able to read, such as a sign or menu, for example. In another embodiment, traveler 422 may understand local person 424 and request the interaction with travel companion 426 for a different purpose other than receiving translations.

In the example, travel companion 426 is located in geographic location 400d. In other examples, travel companion 426 may provide assistance from other geographic locations. Travel companion 426 may receive the audio 428 and captured video from the HMD of traveler 422. Travel companion 426 may hear audio 430 in multiple ways, including through a speaker connected to the computing device, headphones, an HMD, for example. Travel companion 426 may respond with audio 430 through a microphone. In other examples, travel companion 426 may initially start the interaction with traveler 422 by sending a message, visual, or audio 430 to the HMD of traveler 422. The HMD of traveler 422 may play audio 430 from travel companion 426 out loud so that both traveler 422 and local 424 may hear it. In another embodiment, the HMD may only play audio 430 through a headphone so that only traveler 422 may hear the advice or translation from travel companion 426. In an additional example, travel companion may also transmit video in real-time so that the HMD may enable traveler 422 to also see travel companion 426. The HMD may also display visual images and videos from travel companion 426 on the lens of the HMD or projected so that local person 424 may also see the travel companion 426.

In the example, audio 428, 430 represent any possible conversation that may occur between the people in FIG. 4B. Multiple exchanges of audio may occur and in some examples, visuals may also be included. Audio 428, 430 may be recorded along with captured video for future reference by traveler 422 or travel companion 426.

### 5. Example Method to Initiate Interaction

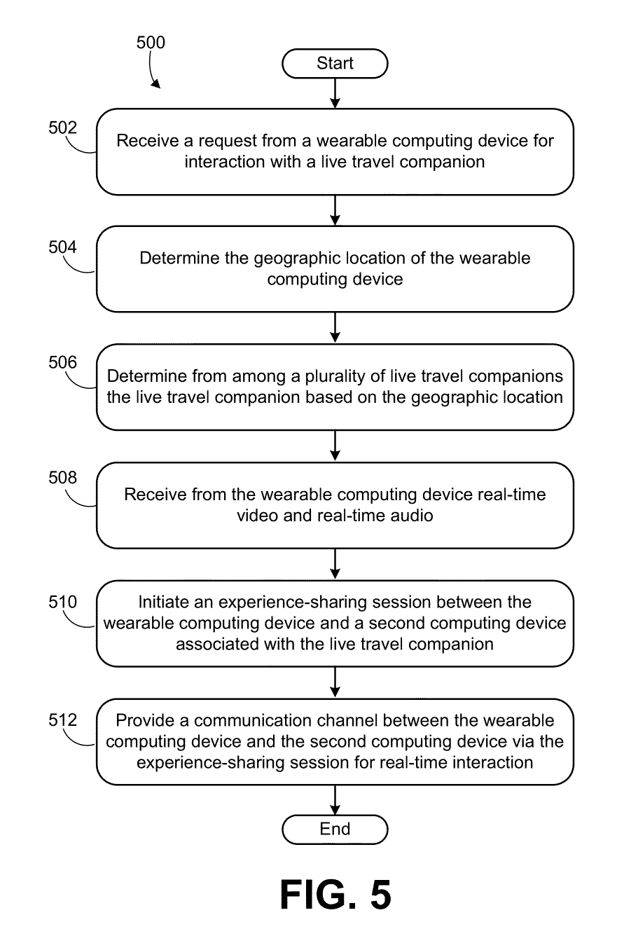

FIG. 5 is a block diagram of an example method for initiating interaction between a traveler and a travel companion. Method 500 illustrated in FIG. 5 presents an example of a method that, for example, could be used with system 100. Further, method 500 may be performed using one or more devices, which may include the devices illustrated in FIGS. 2A-2D, or components of the devices. Method 500 may also include the use of method 300 in FIG. 3. The various blocks of method 500 may be combined into fewer blocks, divided into additional blocks, and/or removed based upon the desired implementation. In addition, each block may represent a module, a segment, or a portion of program code, which includes one or more instructions executable by a processor for implementing specific logical functions or steps in the process. The program code may be stored on any type of computer readable medium, for example, such as a non-transitory storage device including a disk or hard drive.

At block 502, the method 500 includes receiving a request from a wearable computing device for interaction with a live travel companion. The request may be received by a server, and may be a direct request or a time-specific request. A direct request includes immediate connection between the devices of a traveler and travel companion. For example, a traveler may come across a statue that he or she finds intriguing and may perform a direct request to initiate an experience-sharing session to receive information about the statue from a live travel companion. A time-specific request may occur when a connection is made at a time that is predefined prior to the connection. For example, the traveler may choose and set up time-specific requests to automatically initiate an experience-sharing session at the same time every day during a vacation as a daily check-up with the travel companion. In some examples, the request may be sent by a computing device other than a HMD, including but not limited to other wearable computing devices, smart phones, tablets, and laptops. FIGS. 2A-2D illustrate example devices that may be used for interaction between a traveler and a travel companion. Additionally, the request may include the location of the wearable computing device that the request was sent from or other descriptive information that may help the live companion better serve the request. In one example, a traveler may choose to send a request to multiple travel companions in attempts to increase the likelihood of receiving service.

In some examples, the request may be the initial attempt for interaction with a live travel companion. The traveler may be new to the service and may try live interaction for the first time. In other examples, the traveler may have prior experience with the overall service, but this may be the initial interaction with this particular travel companion. In a different example, the request may be an additional request in a series of requests that have already occurred between the same traveler and travel companion. Multiple experience-sharing sessions between the same traveler and travel companion may result in a more comfortable relationship, and thus better enhance the experience of both, the traveler and travel companion.

In some examples, a computing device of the travel companion may send the requests to one or more wearable computers of travelers to initiate experience-sharing sessions. For example, the travel companion may provide information for a tour of a famous museum at the same time daily and may wish to initiate the experience-sharing session with any travelers that previously signed up. Thus, the travel companion may present information on a tour without physically being present in that geographic location to lead the tour.

Furthermore, examples may have various payment structures to enable compensation to occur in exchange for the assistance from travel companions. Some examples provide the service for free or for a specific cost. In one example, a traveler may pay a predefined amount for every request for interaction. This predefined amount may vary over time, may increase, or may lower with the increase of usage to provide an incentive for the travel to use the service more. In one scenario, the traveler may pay for the overall time spent interacting in advance or cover all the costs at the end of usage. Different types of requests or interactions may result in different costs. For example, a tour of a museum may cost more for the traveler than receiving directions to that museum. In another example, every type of request may cost an equal, predefined amount. The traveler may be able to sign up for the service and pay the entire cost upfront and interact with a travel companion an unlimited amount of times. For example, if a traveler knows he or she is about to go on a trip for the next two weeks, the traveler may pay a two week service fee to enable use of the service during the trip, and thus, subscribe to the service. In addition, various locations may cost more than others in some examples. For example, popular tourist locations may cost more due to a higher frequency of requests coming from that geographic location. In one example, requesting and interacting with a travel companion may occur only through the use of a programmed application that may be purchased or downloaded. Additional features to the service may cost extra. For example, the ability for multiple travelers to group interact with a travel companion simultaneously may result in an additional fee.

At block 504, the method 500 includes determining the geographic location of the wearable computing device. The wearable computing device may be configured to determine the geographic location of the wearable computing device and provide such information to a server associated with the live travel companion service. In another example, the wearable computing device may determine its own location and send that location within the request for interaction. The geographic location may be determined through the use of a global positioning system (GPS) or another means of determining location. In one example, a memory storage device may store the location of the wearable computing device and update the location periodically. In another example, a traveler may disclose the geographic location that he or she will require the service for while purchasing the service.

At block 506, the method 500 includes determining from among a plurality of live travel companions the live travel companion based on the geographic location. A server associated with the liver travel companion service may perform the determination. The determination aims to select a travel companion that is assigned to that geographic location. In other examples, the selection of travel companion may be based on other details including the level of expertise of travel companions, availability, number of current incoming requests, or other reasons. A server or another type of computing device may use algorithms to select travel companions based on requests from travelers. In another example, a travel companion may answer requests in the order that the requests are received. Multiple travel companions that all have knowledge about the same geographic location may switch off accepting requests coming from that particular geographic location.

In one example, a wearable computing device of a traveler may connect to a computing device of a travel companion, a person, or entity that receives more information from the traveler about the request. In response to receiving more information, another connection may be made between the traveler and a travel companion that was determined best suited to help fulfill that request. This way the person or entity that initially accepts the request may select the travel companion that may provide the best answer to the request. For example, a wearable computing device of a traveler may send a request to initiate an experience-sharing session with a travel companion for advice during a hike in a state park. A first travel companion, person, or entity may receive the request in the state park and ask one or more questions to determine the purpose behind the request of the traveler. In response to determining that the traveler would like specific information on hiking within that state park, the first travel companion, person, or entity may choose to connect the traveler with a travel companion that has the greatest knowledge about hiking and/or that state park. Examples may also include additional check points or automated services to improve the experience of the traveler.

At block 508, the method 500 includes receiving from the wearable computing device real-time video and real-time audio. In some examples, the computing device of live travel companion may receive the real-time video and real-time audio in an experience-sharing session between devices of the traveler and the live travel companion. The live travel companion may receive the real-time video and real-time audio through a computing device including a tablet, a laptop, wearable computing device, for example. The live travel companion may receive one of the real-time video, the real-time audio, or both. In addition, the live travel companion may receive recorded video, audio, text, or other forms of data transfer. The travel companion may also interact by sending real-time video and real-time audio or other types of information transfer.

At block 510, the method 500 includes initiating an experience-sharing session between the wearable computing device of the traveler and a second computing device associated with the live travel companion. The experience-sharing session may incorporate functions as described in FIG. 3. The experience-sharing session provides each connected device opportunities to communicate through audio and video in real-time.

At block 512, the method 500 includes providing a communication channel between the wearable computing device and the second computing device via the experience-sharing session for real-time interaction. The communication channel may be any type of link that connects the computing device of the travel companion and wearable computing device of the traveler. The link may use one or more networks, wireless or wired portions of data transfer, and other means of permitting interaction to occur. The system may operate in a manner similar to that of the system shown in FIG. 1.

It should be understood that arrangements described herein are for purposes of example only. As such, those skilled in the art will appreciate that other arrangements and other elements (e.g. machines, interfaces, functions, orders, and groupings of functions, etc.) may be used instead, and some elements may be omitted altogether according to the desired results. Further, many of the elements that are described are functional entities that may be implemented as discrete or distributed components or in conjunction with other components, in any suitable combination and location.

While various aspects and examples have been disclosed herein, other aspects and examples will be apparent to those skilled in the art. The various aspects and examples disclosed herein are for purposes of illustration and are not intended to be limiting, with the true scope being indicated by the following claims, along with the full scope of equivalents to which such claims are entitled. It is also to be understood that the terminology used herein is for the purpose of describing particular examples only, and is not intended to be limiting.

1. A method, comprising:
receiving, at a server associated with a travel companion service, a request from a wearable computing device for real-time interaction with a live travel companion who is knowledgeable of aspects of a geographic location of the wearable computing device;
determining the geographic location of the wearable computing device;
selecting from among a plurality of live travel companions associated with the travel companion service, the live travel companion that is assigned to the geographic location of the wearable computing device, wherein each of the plurality of live travel companions is assigned to a given geographic location;
receiving from the wearable computing device real-time video and real-time audio both of which are based on a perspective from the wearable computing device;
initiating an experience-sharing session between the wearable computing device and a second computing device associated with the live travel companion, wherein the experience-sharing session includes receiving the real-time video and real-time audio from the wearable computing device to the second computing device associated with the live travel companion; and
in response to receiving the real-time video and real-time audio from the wearable computing device at the second computing device associated with the live travel companion, providing a communication channel between the second computing device and the wearable computing device via the experience-sharing session for real-time interaction that enables the live travel companion to communicate, based on the real-time video and real-time audio, in real-time to the wearable computing device through the second computing device.

2. The method of claim 1, wherein the aspects of the geographic location include a language spoken in the geographic location, and the method further comprises providing a translation of a portion of the real-time audio received from the wearable computing device.

3. The method of claim 1, further comprising:
receiving a request to subscribe to the travel companion service to which the plurality of live travel companions belong, and
wherein receiving from the wearable computing device the request for interaction with the live travel companion comprises receiving a real-time request based on the subscription to the travel companion service.

4. The method of claim 3, wherein the real-time request is based on a real-time geographic location of the wearable computing device.

5. The method of claim 1, wherein the request for interaction with the live travel companion is based on a prior subscription to the travel companion service to which the plurality of live travel companions belong.

6. The method of claim 5, further comprising:
receiving payment for the prior subscription to the travel companion service.

7. The method of claim 1, wherein the request includes information indicative of the geographic location of the wearable computing device.

8. The method of claim 1, wherein the wearable computing device is configured in an eyeglasses configuration with or without lenses.

9. A non-transitory computer readable medium having stored therein instructions executable by a computing device to cause the computing device to perform functions, the functions comprising:
receiving, at a server associated with a travel companion service, a request from a wearable computing device for real-time interaction with a live travel companion who is knowledgeable of aspects of a geographic location of the wearable computing device;
determining the geographic location of the wearable computing device;
selecting from among a plurality of live travel companions associated with the travel companion service, the live travel companion that is assigned to the geographic location of the wearable computing device, wherein each of the plurality of live travel companions is assigned to a given geographic location;
receiving from the wearable computing device real-time video and real-time audio both of which are based on a perspective from the wearable computing device;
initiating an experience-sharing session between the wearable computing device and a second computing device associated with the live travel companion, wherein the experience-sharing session includes receiving the real-time video and real-time audio from the wearable computing device at the second computing device associated with the live travel companion; and
in response to receiving the real-time video and real-time audio from the wearable computing device at the second computing device associated with the live travel companion, providing a communication channel between the second computing device and the wearable computing device via the experience-sharing session for real-time interaction that enables the live travel companion to communicate, based on the real-time video and real-time audio, in real-time to the wearable computing device through the second computing device.

10. The non-transitory computer readable medium of claim 9, wherein the aspects of the geographic location include a language spoken in the geographic location, and the method further comprises providing a translation of a portion of the real-time audio received from the wearable computing device.

11. The non-transitory computer readable medium of claim 9, further comprising instructions executable by the computing device to cause the computing device to perform a function comprising receiving a request to subscribe to the travel companion service to which the plurality of live travel companions belong, and
wherein receiving from the wearable computing device the request for interaction with the live travel companion comprises receiving a real-time request based on the subscription to the travel companion service.

12. The non-transitory computer readable medium of claim 9, wherein the real-time request is based on a real-time geographic location of the wearable computing device.

13. A system, comprising:
a processor; and
memory configured to store program instructions executable by the processor to perform functions comprising:
receiving from a wearable computing device a request for real-time interaction with a live travel companion that is knowledgeable of aspects of a geographic location of the wearable computing device;
determining the geographic location of the wearable computing device;
selecting from among a plurality of live travel companions associated with a travel companion service, the live travel companion that is assigned to the geographic location of the wearable computing device, wherein each of the plurality of live travel companions is assigned to a given geographic location;
receiving from the wearable computing device real-time video and real-time audio both of which are based on a perspective from the wearable computing device;
initiating an experience-sharing session between the wearable computing device and a second computing device associated with the live travel companion, wherein the experience-sharing session includes receiving the real-time video and real-time audio from the wearable computing device at the second computing device associated with the live travel companion; and
in response to receiving the real-time video and real-time audio from the wearable computing device at the second computing device associated with the live travel companion, providing a communication channel between the second computing device and the wearable computing device via the experience-sharing session for real-time interaction that enables the live travel companion to communicate, based on the real-time video and real-time audio, in real-time to the wearable computing device through the second computing device.

14. The system of claim 13, wherein the aspects of the geographic location include a language spoken in the geographic location, and the method further comprises providing a translation of a portion of the real-time audio received from the wearable computing device.

15. The system of claim 13, wherein the functions further comprise:
receiving a request to subscribe to a service to which the plurality of live travel companions belong; and
wherein the request for interaction with the live travel companion comprises a real-time request based on the subscription to the service.

16. The system of claim 15, wherein the real-time request is based on a real-time geographic location of the wearable computing device.

17. The system of claim 13, wherein the request for interaction with the live travel companion is based on a prior subscription to a service to which the plurality of live travel companions belong.

18. The system of claim 17, wherein the functions further comprise:
receiving payment for the prior subscription to the service.

19. The system of claim 13, wherein the request includes information indicative of the geographic location of the wearable computing device.

20. The system of claim 13, wherein the wearable computing device is configured in an eyeglasses configuration with or without lenses.
